(19) United States
(12) Patent Application Publication
(10) Pub. No.: US 2014/0179265 A1
(43) Pub. Date: Jun. 26, 2014

(54) Method For Offering Wireless Data At A Discounted Rate

(71) Applicants: Glenn R. Bruns, Naperville, IL (US); Bruce R. Cilli, Atlantic Highlands, NJ (US); Atul Divekar, Naperville, IL (US); Chuck R. Payette, Oceanport, NJ (US)

(72) Inventors: Glenn R. Bruns, Naperville, IL (US); Bruce R. Cilli, Atlantic Highlands, NJ (US); Atul Divekar, Naperville, IL (US); Chuck R. Payette, Oceanport, NJ (US)

(21) Appl. No.: 13/723,434

(22) Filed: Dec. 21, 2012

(51) Int. Cl. H04W 28/08

(52) U.S. Cl. CPC H04W 28/08
USPC 455/406

(57) ABSTRACT

A method for offering wireless data at a discounted rate is provided. A wireless service provider is queried to discover discounted data transfer rates. A discount rate proposal is sent to the querying mobile user. The discount rate proposal includes a discount rate, a data bit rate, and an offered time period. If the mobile unit accepts the discount rate proposal, user data is carried at the data bit rate during the offered time period priced at the discount rate.

### FIELD OF THE INVENTION

The present invention relates generally to communication systems.

### BACKGROUND OF THE INVENTION

Wireless data traffic has increased greatly in recent years, forcing wireless service providers (WSPs) to upgrade their networks. One problem is that the capacity of wireless networks must currently be upgraded according to peak cell utilization, rather than average cell utilization. For example, typical wireless networks operate at roughly 30% of capacity. Capital expense costs for WSPs could be reduced if these utilization peaks were smoothed.

A possible solution to smoothing peaks in cell utilization would be to allocate less cell capacity to users who have less need for bandwidth. However, there are currently no mechanisms in place for a WSP to learn of the bandwidth needs of individual users.

The best existing solution to the problem is for the WSP to engineer the system to limit overloads by controlling call admissions, cell balancing and capacity engineering. Assigning certain types of traffic, such as voice or video, to a higher priority QoS and/or guaranteeing its bit rate can also help mitigate the ill effects of congestion for that traffic. However, giving certain types of traffic high priority does not help in reducing peak utilization. Furthermore, prioritizing traffic based on its type does not necessarily serve the needs of the WSP's users. For example, a user about to board a flight may want a movie download to proceed as quickly as possible, but the download will only receive best effort treatment. Another user may care only that the movie downloads within two or three hours, and in this case even normal, best effort treatment is not required.

Therefore, a need exists for a way of providing more optimal data traffic utilization in wireless communication systems.

### BRIEF SUMMARY OF THE INVENTION

An exemplary embodiment provides for a WSP to offer lower-speed wireless data at a discount to users when cell utilization is high. The price can be set dynamically depending on the level of cell utilization. Users could then decide whether to accept the discount depending on their data needs. For example, this provides a method by which the WSP can learn of the users' requirements.

In accordance with an exemplary embodiment, a user utilizes an application on their mobile unit to query the WSP at any time for discounts. The WSP preferably responds with a discount rate, a data bit rate, plus a time period over which the discount rate is valid. The user can then ignore this discount offer, or accept by responding to the WSP. If the offer is accepted, the user's data traffic is carried at the offered bit rate over the time window, and the price of the data during this period is set according to the offer.

Discounts preferably take the form of a reduction in how bits sent or received are counted against the user's monthly data quota. For example, the discount for a lowered bit rate might be 0.5, meaning that every bit sent or received by a user is counted as only half a bit.

The incentive to agree to a lower bit rate may be an offer of additional bits to be added to the users monthly quota or an offer of free or reduced price bits at a time of lesser network utilization.

The WSP may also send discount advertisements to opted-in users as well, possibly sometime in advance of the period for which the discount is applicable. The same procedure as stated above is then applied if the user accepts the offer.

### BRIEF DESCRIPTION OF THE SEVERAL VIEWS OF THE DRAWINGS

FIG. 1 depicts the functional architecture of a communication network in accordance with an exemplary embodiment of the present invention.

FIG. 2 depicts a call flow diagram in accordance with an exemplary embodiment of the present invention.

### DETAILED DESCRIPTION OF THE INVENTION

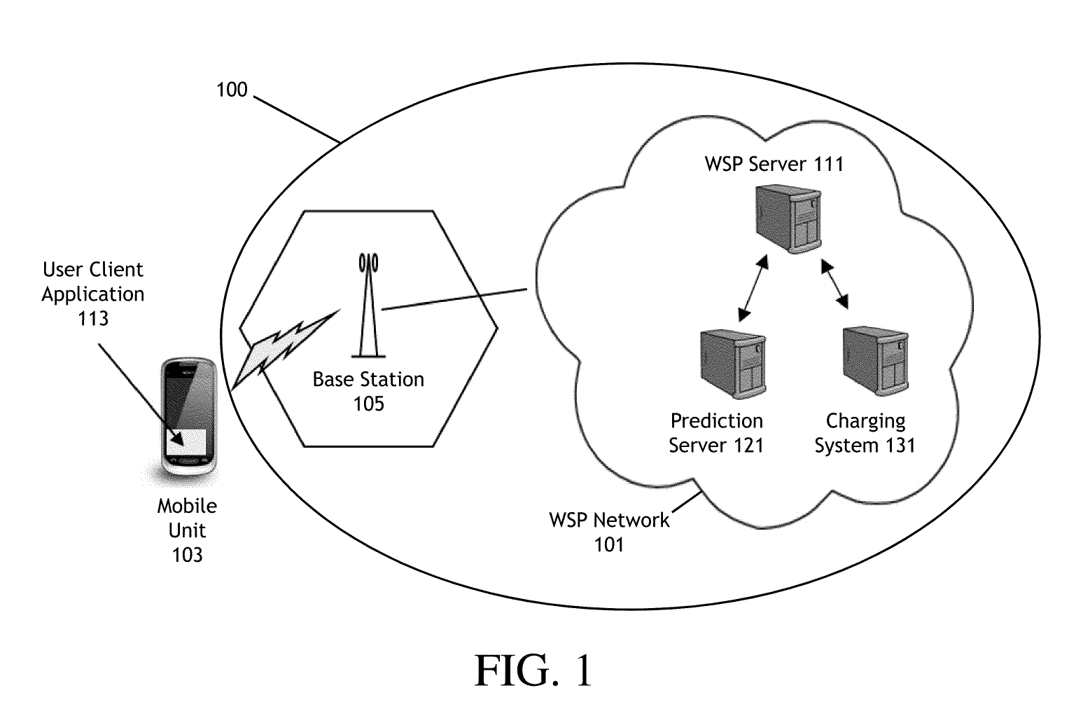

FIG. 1 depicts the functional architecture of communication network 100 in accordance with an exemplary embodiment of the present invention. Communication network 100 preferably includes wireless network 101 and mobile unit 103. Communication network can be any suitable wireless network.

Wireless network 101 preferably includes base station 105, wireless service provider (WSP) server 111, prediction server 121, and charging system 131.

Base station 105 is a wireless communications station installed at a fixed location and used to communicate with mobile units and network elements located within wireless network 101. Although only one base station (base station 105) is depicted in FIG. 1 for clarity, it should be understood that a typical wireless network includes a plurality of base stations.

WSP server 111 is preferably responsible for receiving user requests, for sending offers in response to these requests, and for receiving user acceptances of offers.

Prediction server 121 is preferably responsible for predicting utilization levels of cells in the WSP network.

Charging system 131 is a server that provides processing of information relating to charging mobile unit 103 for data used.

Mobile unit 103 is a mobile unit that can communicate with wireless network 101. Mobile unit 103 can be, for example, a smart phone or tablet. Mobile Unit 103 preferably includes a user client application 113.

User client application 113 preferably utilizes a “RESTful” API, typically implemented as messages in the XML format over the HTTP protocol used for web traffic.

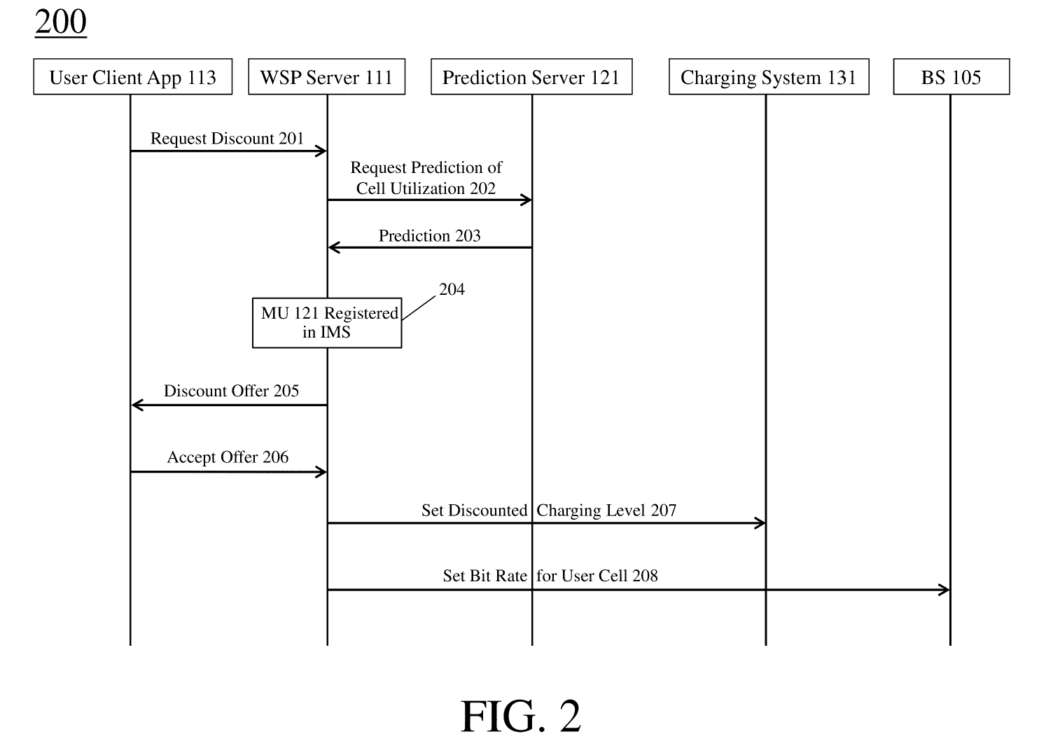

FIG. 2 depicts a call flow diagram 200 in accordance with an exemplary embodiment of the present invention.

User client application 113 sends Request Discount message 201 to WSP Server 111. Request Discount message preferably includes an identification of mobile unit 103.

WSP Server 111 sends Request Prediction of Cell Utilization message 202 to Prediction Server 121.

Prediction Server 121 sends Prediction message 203 to WSP Server 111.

WSP Server 111 computes (204) the terms of any discount offer. Upon receiving the request, WSP Server 111 computes the elements of the offer, preferably based on user information and predicated cell utilization, which is obtained from Prediction Server 121. In accordance with an exemplary embodiment, the elements of the offer include a discount rate, a data rate, and an offered time period.

WSP Server 111 sends Discount Offer message 205 to User client application 113. Discount Offer message 205 preferably includes a digital signature so that a user could not “spoof” the WSP Network 111 by accepting a discount never actually offered by WSP Network 111.

If the user wants to accept the offer sent in Discount Offer message 205, User client application 113 sends Accept Offer message 206 to WSP Server 111. WSP Server 111 would then implement the reduced bandwidth rate, preferably using mechanisms that are available at the cell site. In an exemplary embodiment, this is accomplished by limiting total traffic throughput. In an alternate exemplary embodiment, this is accomplished via reducing the priority through QoS settings. In addition, both of these can be used in conjunction. WSP Network 111 can alternately offload mobile unit 103 to an alternative access network, not shown. Additionally, a user that accepts an offer is preferably able to terminate the terms of the offer at any time during the period of the offer.

In response to receiving Accept Offer message 206, WSP Server 111 sends Set Discounted Charging Level message 207 to Charging System 131. In addition, WSP Server 111 preferably updates the billing system on the way bits are counted towards the user's monthly quota in accordance with the offer.

WSP Server 111 sends Set Bit Rate for User Cell message 208 to base station 105, which implements the bit rate discounted offered to and accepted by mobile unit 103. In an exemplary embodiment, wireless network 101 is an LTE network and the mechanism for bit-rate control comprises reducing the amount of user traffic allowed for best effort flows through the eNodeB by lowering the user's UE-AMBR setting. This could also be accomplished by lowering settings and limiting bandwidth for the user in the packet gateway, such as via APN-AMBR.

In a further exemplary embodiment, wireless network 101 is an LTE network and the mechanism for bit-rate control comprises establishing a guaranteed bit rate (GBR) bearer to a very low value that will carry all of the user traffic, effectively reducing the user's rate proportionally compared to best effort users. In a further exemplary embodiment, wireless network 101 is an LTE network and the mechanism for bit-rate control comprises assigning discount traffic to a QCI (QoS) value that has a lower priority than standard best effort. For example, discount users would be assigned the lowest QCI value of 9. In a further exemplary embodiment, users can be offloaded to a slower network, such as CDMA or W-CDMA.

An exemplary embodiment of the present invention thereby provides for reduced peak cell utilization, thereby reducing WSP capital expenditure. In accordance with an exemplary embodiment, a user can transmit more data each month without any perceived loss of utility. This facilitates users getting more value from their monthly data quota. Furthermore, user satisfaction is increased for all of the WSP's users, because wireless data performance decreases at times of high utilization. This increased user satisfaction is in turn a benefit to the WSP, for example in retaining customers.

While this invention has been described in terms of certain examples thereof, it is not intended that it be limited to the above description, but rather only to the extent set forth in the claims that follow.

We claim:

1. A method for offering wireless data, the method comprising:
querying a wireless service provider for discounted data transfer rates;
sending a discount rate proposal; and
accepting the discount rate proposal.

2. A method for offering wireless data in accordance with claim 1, wherein the discount rate proposal comprises a discount rate.

3. A method for offering wireless data in accordance with claim 2, wherein the discount rate comprises a reduction in how bits sent or received are counted against a monthly data quota.

4. A method for offering wireless data in accordance with claim 1, wherein the discount rate proposal comprises a data bit rate.

5. A method for offering wireless data in accordance with claim 1, wherein the discount rate proposal comprises an offered time period.

6. A method for offering wireless data in accordance with claim 1, the method further comprising the step of terminating the terms of the offer prior to using the discount rate proposal.

7. A method for offering wireless data in accordance with claim 1, wherein the step of sending a discount rate proposal comprises computing the discount rate proposal.

8. A method for offering wireless data in accordance with claim 7, wherein the step of computing the discount rate proposal comprises computing the discount rate proposal utilizing information from the requesting user.

9. A method for offering wireless data in accordance with claim 7, wherein the step of computing the discount rate proposal comprises computing the discount rate proposal utilizing predicated cell utilization.

10. A method for offering wireless data in accordance with claim 1, wherein the step of sending a discount rate proposal comprises sending a discount rate proposal including a digital signature.

11. A method for offering wireless data at a discounted rate, the method comprising:
querying a wireless service provider for discounted data transfer rates;
sending a discount rate proposal, the discount rate proposal comprising a discount rate, a data bit rate, and an offered time period;
accepting the discount rate proposal; and
carrying user data at the data bit rate during the offered time period priced at the discount rate.

12. A method for offering wireless data at a discounted rate in accordance with claim 11, wherein the step of carrying user data comprises limiting total traffic throughput.

13. A method for offering wireless data at a discounted rate in accordance with claim 11, wherein the step of carrying user data comprises reducing the priority through QoS settings.

14. A method for offering wireless data at a discounted rate in accordance with claim 11, wherein the step of carrying user data comprises offloading the carrying of the user data to an alternative access network.

15. A method for offering wireless data at a discounted rate in accordance with claim 11, wherein the step of carrying user data comprises lowering a UE-AMBR setting associated with the user.

16. A method for offering wireless data at a discounted rate in accordance with claim 11, wherein the step of carrying user data comprises establishing a guaranteed bit rate (GBR) bearer to a very low value that will carry all of the user traffic.

17. A method for offering wireless data at a discounted rate in accordance with claim 11, wherein the step of carrying user data comprises assigning the user data to a QCI (QoS) value that has a lower priority than standard best effort.

18. A method for offering wireless data at a discounted rate, the method comprising:
receiving an advertisement at a mobile user, the advertisement including a discount rate proposal, the discount rate proposal comprising a discount rate, a data bit rate, and an offered time period;
accepting the discount rate proposal; and
carrying user data at the data bit rate during the offered time period priced at the discount rate.

19. A method for offering wireless data at a discounted rate in accordance with claim 18, the method further comprising the step of adding additional bits to the monthly quota of the mobile unit.

20. A method for offering wireless data at a discounted rate in accordance with claim 18, the method further comprising the step of providing reduced price bits at a time of lesser network utilization.
